(19) United States
(12) Patent Application Publication
(10) Pub. No.: US 2020/0320539 A1
(43) Pub. Date: Oct. 8, 2020

(54) System for Projecting Warranty Cost for Electronic Information System Based on Customer-Specific Usage Data

(71) Applicant: Dell Products L.P., Round Rock, TX (US)

(72) Inventors: Sai Kishore Vanga, Andhra Pradesh (IN); Ravishankar Kanakapura Nanjundaswamy, Bangalore (IN); Muniswamy Setty K S, Bangalore (IN)

(73) Assignee: Dell Products L.P., Round Rock, TX (US)

(21) Appl. No.: 16/376,577

(22) Filed: Apr. 5, 2019

(51) Int. Cl. G06Q 30/00; G06Q 30/02

(52) U.S. Cl. CPC G06Q 30/012; G06Q 30/0283

(57) ABSTRACT

A method, system and computer-usable medium are disclosed for determining a projected warranty cost for use of an electronic product comprising: generating a warranty cost projection model based on historical usage data associated with the electronic product; acquiring customer specific usage data for the electronic product of an existing customer, wherein the customer specific usage data includes usage data acquired from the electronic product during operation of the electronic product by the existing customer; and determining a warranty cost projection for use of the electronic product by the existing customer, wherein the warranty cost projection is determined by applying the customer specific usage data to the warranty cost projection model.

### BACKGROUND OF THE INVENTION

### Field of the Invention

The present invention relates to information handling systems. More specifically, embodiments of the invention relate to projecting warranty cost for an electronic product, such as an enterprise server, based on usage data.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Manufactures, retailers, OEMs, etc., provide various configurations of such information systems to their customers. Most transactions involving such information systems involve one or more warranties. In certain contracts accompanying a product transaction, the warranty provides a written promise from a company to repair, replace, and/or service a product within a particular period of time. In certain embodiments, the warranty period is calculated based on the sale date of the information system and the type of information system that is the subject of the transaction without factoring for other attributes relating to the health of the information system.

### SUMMARY OF THE INVENTION

A system of one or more computers can be configured to perform particular operations or actions by virtue of having software, firmware, hardware, or a combination of them installed on the system that in operation causes or cause the system to generate and apply a model to project the warranty cost associated with the use of an electronic product. One or more computer programs can be configured to perform particular operations or actions by virtue of including instructions that, when executed by data processing apparatus, cause the apparatus to generate and apply a model to project the warranty cost associated with the use of an electronic product. Certain embodiments are directed to a computer-implemented method for determining a projected warranty cost for use of an electronic product including: generating a warranty cost projection model based on historical usage data associated with the electronic product; acquiring customer specific usage data for the electronic product of an existing customer, where the customer specific usage data includes usage data acquired from the electronic product during operation of the electronic product by the existing customer; and determining a warranty cost projection for use of the electronic product by the existing customer, where the warranty cost projection is determined by applying the customer specific usage data to the warranty cost projection model. Other embodiments of this aspect include corresponding computer systems, apparatus, and computer programs recorded on one or more computer storage devices, each configured to perform the actions of the methods.

Certain embodiments are also directed to a system including: a processor; a data bus coupled to the processor; and a non-transitory, computer-readable storage medium embodying computer program code, the non-transitory, computer-readable storage medium being coupled to the data bus, the computer program code interacting with a plurality of computer operations and including instructions executable by the processor and configured for: generating a warranty cost projection model based on historical usage data associated with an electronic product; acquiring customer specific usage data for use of the electronic product by an existing customer, where the customer specific usage data includes usage data acquired from the electronic product during operation of the electronic product by the existing customer; and determining a warranty cost projection for the electronic product by the existing customer, where the warranty cost projection is determined by applying the customer specific usage data to the warranty cost projection model. Other embodiments of this aspect include corresponding computer systems, apparatus, and computer programs recorded on one or more computer storage devices, each configured to perform the actions of the methods.

Certain embodiments are also directed to a non-transitory, computer-readable storage medium embodying computer program code, the computer program code including computer executable instructions configured for: generating a warranty cost projection model based on historical usage data associated with an electronic product; acquiring customer specific usage data for use of the electronic product by an existing customer, where the customer specific usage data includes usage data acquired from the electronic product during operation of the electronic product by the existing customer; and determining a warranty cost projection for the electronic product by the existing customer, where the warranty cost projection is determined by applying the customer specific usage data to the warranty cost projection model. Other embodiments of this aspect include corresponding computer systems, apparatus, and computer programs recorded on one or more computer storage devices, each configured to perform the actions of the methods.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention;

FIG. 2 is a block diagram of an electronic environment in which certain embodiments of the invention may be employed;

FIG. 3 shows one example of an electronic environment in which a server may operate to implement certain embodiments of the invention;

FIG. 4 is a flowchart depicting exemplary operations that may be executed by a cognitive warranty system; and

FIG. 5 depicts one example of a neural network that may be used in a warranty cost model in certain embodiments of the invention.

### DETAILED DESCRIPTION

A system, method, and computer-readable medium are disclosed for determining a projected warranty cost for use of an electronic information system. Certain aspects of the invention reflect an appreciation that is common for many organizations to employ a single set of warranty terms when providing an electronic information processing system in a transaction with a customer. As used herein, the term “customer” includes, without limitation, an entity purchasing the electronic information system, an entity leasing the electronic information system, an end user of the electronic information system, etc. Certain aspects of the invention also recognize that a single set of warranty terms may not be optimal in determining warranty costs transactions involving different customers. As an example, certain customers may place different degrees of workload on the information processing system. In such situations, the warranty cost associated with high workload customers may be greater than the warranty cost associated with a customer who places a lower workload on the information processing system. As a further example, certain customers may operate the electronic product in a harsh ambient environment that stresses the components of the electronic product. In certain instances, the warranty cost for supporting such customers may be greater than the warranty cost for supporting customers using the product in a more suitable, controlled ambient environment.

Certain aspects of the invention recognize that an organization may allocate its inventory, service operations, etc. in a more effective manner by customizing the warranty for an information processing system based on the manner in which the information processing system has been used by a customer in the past. As used herein, the term “organization” includes, without limitation, an entity that sells, leases, repairs, supports, etc., the use of the information processing system. As an example, an organization may stock more parts and/or allocate more resources to a customer having a higher projected warranty cost than to a customer having a lower projected warranty cost. As a further example, customers having a higher projected warranty cost may be subject to different warranty terms, service contract payments, etc., than customers having a lower projected warranty cost. As such, an accurate projection of warranty cost for a particular customer provides physical benefits associated with the allocation of inventory, warehousing, manpower, service equipment, etc.

Certain aspects of the invention recognize that it may be difficult to project warranty costs for a particular customer. Certain embodiments of the invention address this technical problem by tracking usage data associated with an information processing system by a customer over time. In certain embodiments, the usage data may be employed to develop a model for projecting the warranty cost associated with future transactions involving the same and/or similar information processing system operated by the same customer. Certain aspects of the invention recognize that a warranty cost projection model may be generated based on usage data associated with the information processing system acquired during operation of the system by the customer. In certain instances, the warranty cost projection model may be generated using general usage information acquired from multiple customers operating the information processing system product under different usage conditions. In certain instances, the warranty cost projection model may be generated using customer specific usage information acquired from an existing information processing system during operation of the product by an existing customer. In certain instances, a warranty cost projection for an additional acquisition of the information processing system by the existing customer may be determined using the warranty cost projection model generated for the existing customer.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

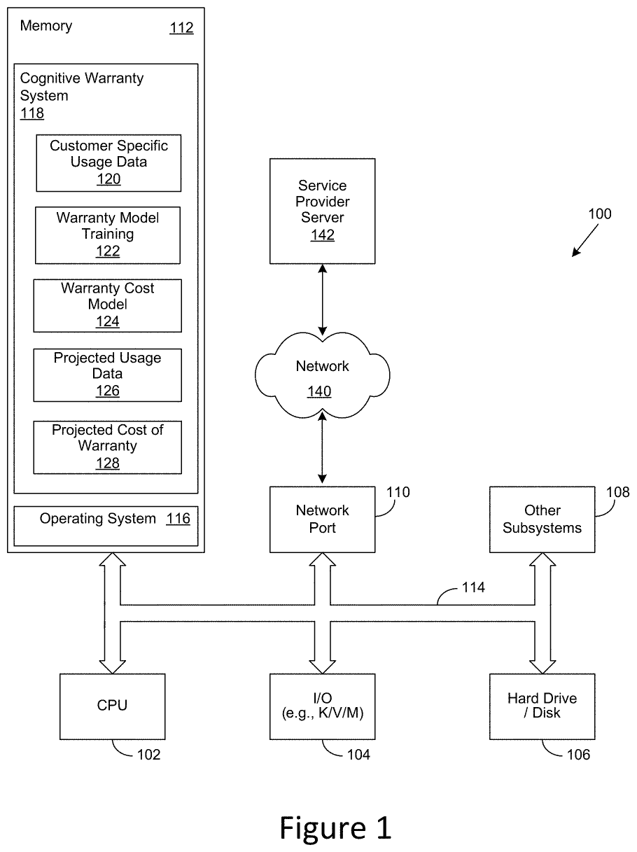

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a cognitive warranty system 118. In certain embodiments, the cognitive warranty system 118 may include customer specific usage data 120 obtained from another information processing system during its operation by a customer. In certain embodiments, the cognitive warranty system 118 includes a warranty model training module 122, which may use the customer specific usage data 120 to generate a warranty cost model 124 that, for example, may be specific to an existing customer. In certain embodiments, the warranty cost model 124 may accept projected usage data 126 associated with the projected use of the electronic product by the existing customer to generate a projected cost of the warranty 128 for a subsequent transaction involving the electronic product with the existing customer. In one embodiment, the information handling system 100 is able to download one or more portions of the cognitive warranty system 118 from the service provider server 142. In another embodiment, the one or more portions of the cognitive warranty system 118 may be provided as a service from the service provider server 142.

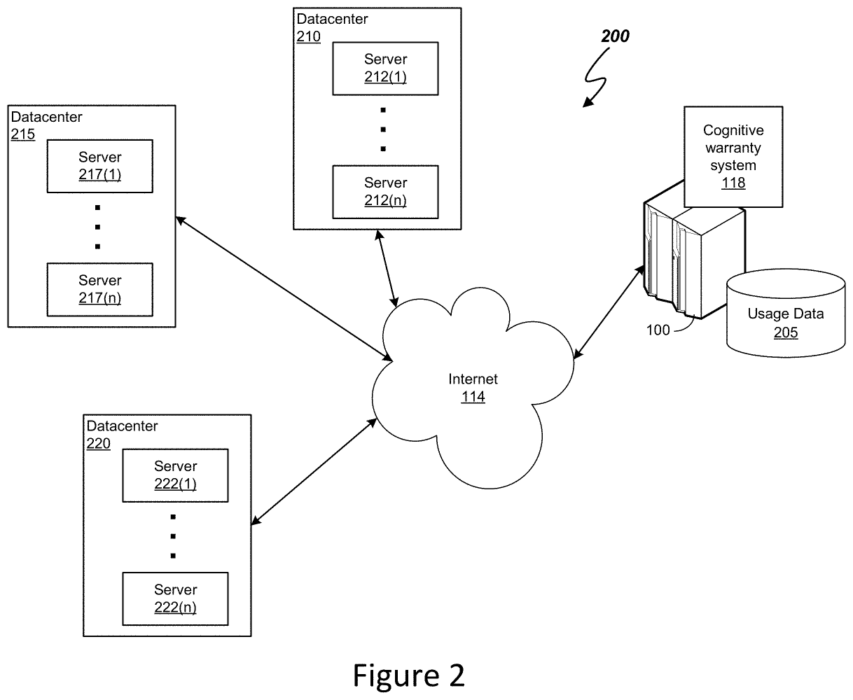

FIG. 2 is a block diagram of an electronic environment 200 in which certain embodiments of the invention may be employed. In certain embodiments, the electronic environment 200 may include the information processing system 100 configured with the cognitive warranty system 118 and a repository of usage data 205 configured to store usage data associated with an electronic product operated by an existing customer. In the specific examples shown in FIG. 2, the electronic product is an information handling system configured as an enterprise server.

In certain embodiments, the electronic environment 200 includes a plurality of DataCenters 210, 215, and 220, which may be operated by the same or different customers in the same or different operating environments. In certain embodiments, each DataCenter 210, 215, and 220 may include one or more servers. In the example shown in FIG. 2, DataCenter 210 includes a plurality of servers 212(1) through 212(n), DataCenter 215 includes a plurality of servers 217(1) through 217(n), and DataCenter 220 may include a plurality of servers 222(1) through 222(n). In certain embodiments, the servers at one or more of the DataCenters 210, 215, and 220 may be configured as enterprise servers. In certain embodiments, the DataCenters 210, 215, and 220 may communicate with the cognitive warranty system 118 over a network, such as the Internet 114.

In certain embodiments, the cognitive warranty system 118 collects usage data from, for example, the servers operating at each of the DataCenters 210, 215, and 220, and stores the usage data in the repository of usage data 205. In certain embodiments, the usage data is specific to the servers used by a particular customer. In certain embodiments, the usage data may include usage data respectively associated with each of the enterprise servers at each of the DataCenters 210, 215, and 220. In such instances, the usage data specific to a given server (e.g., 212(1)) may be used to generate a model for projecting the warranty cost for a replacement of the given server. In certain embodiments, the usage data specific to a given server (e.g., 212(1)) may be used to generate a model for projecting the warranty cost for the same server type at the same DataCenter (e.g., 210). As an example, if the given server has a configuration “X”, then the usage data specific to configuration “X” may be used to generate a model for projecting a warranty cost associated with the addition of another server having configuration “X” that is to operate at the same DataCenter. In certain embodiments, usage data specific to configuration “X” may be used to generate a model for projecting warranty cost associated with the addition of a server having the same configuration at another DataCenter. Additionally, or in the alternative, the usage data may include data corresponding to the aggregate usage of the servers at a given DataCenter 210, 215, or 220. For example, usage data for servers 212(1) through 212(n) at DataCenter 210 may be aggregated to generate a single model for projecting the warranty cost for an additional or replacement server at DataCenter 210.

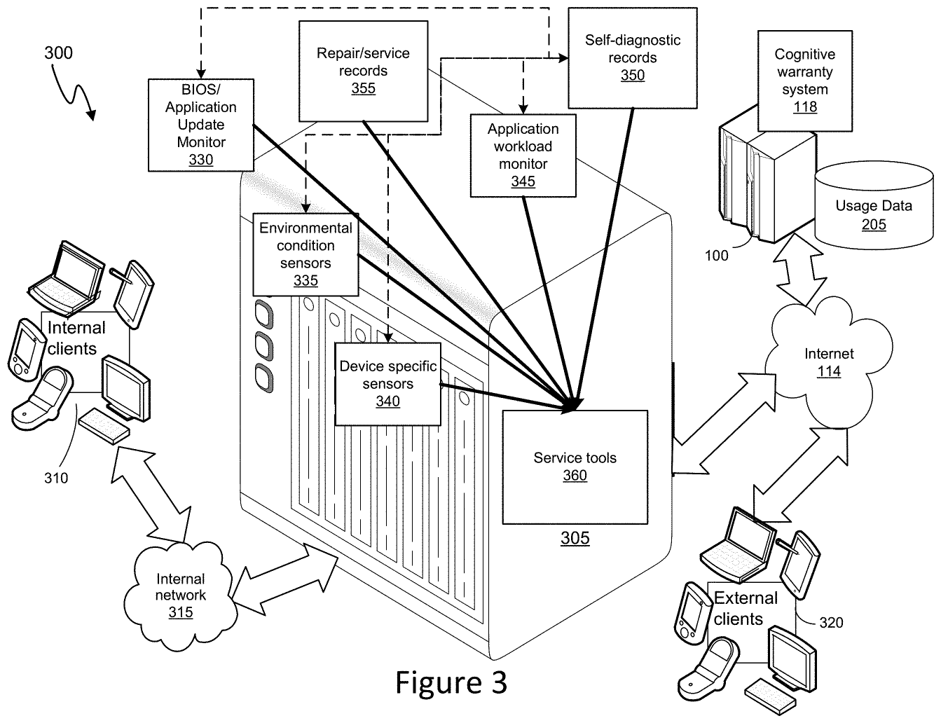

FIG. 3 shows one example of an electronic environment 300 in which a server 305 may operate to implement certain embodiments of the invention. In certain embodiments, the electronic environment 300 is configured as a client-server system. As used herein, the client—server system is a distributed application structure that partitions tasks or workloads between the providers of the server 305, and service requesters, called clients, shown in FIG. 3 as internal clients 310 and external clients 320. In certain embodiments, one or more internal clients 310 may communicate with the server 305 over an internal network 315, and one or more external clients 320 may communicate with the server 305 over an external network, such as the Internet 114. In certain embodiments, the clients and servers may communicate over a computer network on separate hardware, but both client and server may reside in the same system. In certain embodiments, the server 305 runs one or more server programs which share their resources with the clients 315 and 320. In certain embodiments, the clients 315 and 320 typically do not share their resources, but, rather request content or a service function from the server. In certain embodiments, clients initiate communication sessions with servers which await incoming requests. Examples of computer applications that use the client—server model are Email, network printing, and the World Wide Web.

The exemplary server 305 may monitor various aspects of its on-site operation at its corresponding DataCenter. In certain embodiments, the server 305 may include a BIOS/application update monitor 330, which may be used to provide a record of the BIOS and application updates that have been executed on the server 305. In certain embodiments, the update information may be used in generating a warranty model that considers the cost of updating the server 305. In certain embodiments, the update information may also determine whether the customer maintains the server 305 to comply with mandatory and/or recommended updates suggested by the seller. In certain embodiments, such updates may increase the efficiency of the hardware and/or software used on the server 305, or otherwise solve problems that may be associated with the hardware and/or software. In certain embodiments, regular updates to the server 305 may reduce the time between failures. As an example, regular updates to the server 305 may reduce the number of resources needed to respond to client requests thereby extending the life of the server 305. As a further example, certain updates may result in increased efficiency of the operation of certain components (e.g., a power supply, CPU, RAM, storage devices, etc.) thereby decreasing the cost of the warranty. In contrast, some customers may fail to regularly update the BIOS and/or applications of the server 305 and, as such, introduce wear factors, that increase the cost of the warranty.

Certain embodiments of the server 305 may also include environmental condition sensors 335 that are configured to sense the attributes of the ambient environment in which the server 305 is operating. In certain examples, the environmental condition sensors 335 may include temperature and/or humidity sensors that provide information on the temperature and/or humidity of the ambient environment. In certain examples, the information may be provided as a non-binary function of the temperature and/or humidity in which the temperature and/or humidity is provided as a value that directly correlates with the measurement. In certain examples, the information may be provided as a binary function of the temperature and/or humidity to indicate whether the temperature and/or humidity have exceeded and/or fallen below predetermined threshold values. It will be recognized, in view of the teachings of the present disclosure, that various types of ambient environment data may be monitored and presented in various data formats, the foregoing merely being examples that are not intended to limit the scope of the invention.

In certain embodiments, the server 305 may include device specific sensors 340 that monitor various operating conditions of components used within the server 305. In certain embodiments, such device specific sensors 340 may monitor the temperature(s) of one or more of a CPU, memory chip, network card, a hard disk drive, etc. In certain embodiments, the specific device sensors 340 may provide information relating to the actual failure of one or more such components. In certain embodiments, the specific device sensors 340 may provide information relating to factors (e.g., component temperatures, customer over clocking of certain devices, etc.) that may result in failure of one or more such components. In certain examples, the information may be provided as a non-binary function of the factors in which the factors are provided as values that directly correlate with the measurements. In certain examples, the information may be provided as a binary function of the factors to indicate whether the factors have exceeded and/or fallen below predetermined threshold values. It will be recognized, in view of the teachings of the present disclosure, that various types factors may be monitored and presented in various data formats, the foregoing merely being examples that are not intended to limit the scope of the invention.

In certain embodiments, the server 305 may include an application workload monitor 345 configured to monitor the workload placed upon the server 305. In certain embodiments, the application workload monitor 345 may be used to monitor workload factors, such as, for example: 1) the average number of clients accessing the server 305 at a given time; 2) the average number of clients accessing the server 305 over a given time period; 3) which applications experience the most use at a given time; 4) which applications experience the most use over a given time period; 5) which applications require the most system resources (e.g., CPU time, storage access, memory, etc.) for their execution; etc. In certain examples, the information may be provided as a non-binary function in which the application workload factors are provided as a value within a range of multiple numerical values correlate with the workload factor measurement. In certain examples, the information may be provided as a binary function to indicate whether the application workload factors have exceeded and/or fallen below the predetermined threshold values. It will be recognized, in view of the teachings of the present disclosure, that various types of application workload factors may be monitored and presented in various data formats, the foregoing merely being examples that are not intended to limit the scope of the invention.

Certain embodiments may include one or more self-diagnostic applications that generate self-diagnostic records 350. In certain embodiments, the self-diagnostic records 350 may include diagnostic information relating to disk drive status, memory status, etc. In certain embodiments, the self-diagnostic records may include information provided by one or more of the BIOS/application update monitor 330, the environmental condition sensors 335, the device specific sensors 340, the device specific sensors 340, and/or the application workload monitor 345.

In certain embodiments, the server 305 may include repair/service records 355 associated with repairs and/or services associated with the server 305. In certain embodiments, such records may be generated and stored on the server 305 when the server is the subject of an on-site service call and/or remote service call. In certain embodiments, records corresponding to phone calls made by the customer to the seller (e.g., calls made to a service and/or repair center relating to the server 305) may be generated at the seller and pushed to the server 305 for storage in the repair/service records 355. Additionally, or in the alternative, certain embodiments may store such repair and service records at the seller site. In certain embodiments, the repair/service records 355 may be updated manually at the server 305 through a user interface of the server by an individual who performs an on-site service and/or repair of the server. It will be recognized, in view of the teachings of the present disclosure, that various types of repair/service records may be stored and utilized in the model generation, the foregoing merely being examples that are not intended to limit the scope of the invention.

Certain embodiments of the server 305 include one or more service tools 360 that can communicate with one or more of the BIOS/application update monitor 330, environmental condition sensors 335, the device specific sensors 340, the application workload monitor 345, the self-diagnostic records 350, and/or repair/service records 355. In certain embodiments, the cognitive warranty system 118 may communicate with the service tools 360 over the Internet 114 to communicate usage data specifically related to the server 305 for storage in the usage data 205. The usage data 205 for the server 305 may be used to generate a projected warranty cost model, as described herein.

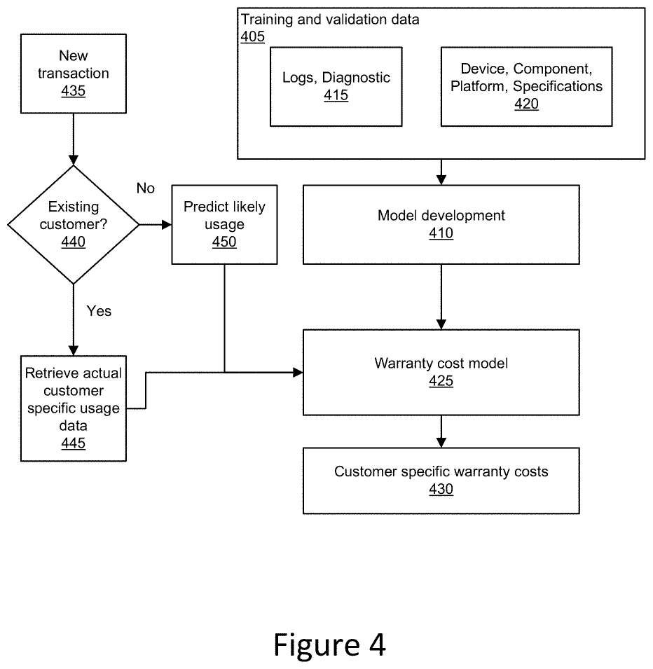

FIG. 4 is a flowchart depicting exemplary operations that may be executed by the cognitive warranty system 118. In certain embodiments, the cognitive warranty system 118 uses training and validation data 405 in a model development operation, shown at operation 410. In certain embodiments, the training and validation data includes specific usage data associated with operation of an information processing system, such as a server, by one or more existing customers. In certain embodiments, the training and validation data 405 may include customer specific logs and diagnostic information 415 obtained during operation of an information processing by a customer. Such information may include dynamic data, such as, without limitation, error alerts, environmental alerts, system diagnostics, BIOS/Application update information, etc., that occur during operation of the information processing system. In certain embodiments, the training and validation data may include device, component, platform, and specification data 420. In certain embodiments, the component, platform, and specification data 420 may include, without limitation, processor type, memory type, operating systems type, etc.

In certain embodiments, the model development operations 410 result in the generation of a warranty cost model 425. In certain instances, the warranty cost model 425 may be used to project customer specific warranty costs 430, as described herein. In certain instances, the customer specific warranty costs 430 may be used to define the warranty terms that are to be used in a particular transaction involving the customer. In certain instances, the warranty terms may include, for example, the length of the warranty, the cost of service and/or repair provisions of the warranty, charges to the customer for various warranty levels, etc.

In certain embodiments, the information provided to the warranty cost model 425 may depend on whether a transaction involves a new customer or an existing customer. As shown in the example of FIG. 4, a new transaction involving the customer is initiated at operation 435. In certain instances, the new transaction involves an information processing system product type for which the warranty cost model 425 was specifically trained. In certain instances, the new transaction involves an information processing system product similar to the product for which the warranty cost model 425 was previously trained.

In certain embodiments, a determination is made at operation 440 as to whether the new transaction at operation 435 involves a new or existing customer. If the new transaction involves an existing customer, the actual customer specific usage data for and information processing system operated by the existing customer is retrieved at operation 445. In certain embodiments, the customer-specific usage data may be retrieved from the repository of usage data 205. In certain embodiments, the usage data may be retrieved in real-time from one or more information processing systems operated by the existing customer. In certain embodiments, the customer-specific usage data retrieved at operation 445 is provided as input to the warranty cost model 425, which generates corresponding customer specific warranty costs 430.

If a determination is made at operation 440 that the new transaction and operation 435 does not involve an existing customer, the default warranty provisions associated with the information processing system involved in the new transaction 435 may be used. In certain embodiments, the organization may enter a prediction for the usage data that will likely be associated with the new customer at operation 450. In certain embodiments, the organization may predict usage based on information provided by the new customer. In certain embodiments, the organization may predict usage based on a field inspection of the environment and circumstances in which the information processing system will be employed. It will be recognized, in view of the teachings of the present disclosure, that predictions that take place at operation 450 may be made in a variety of different manners.

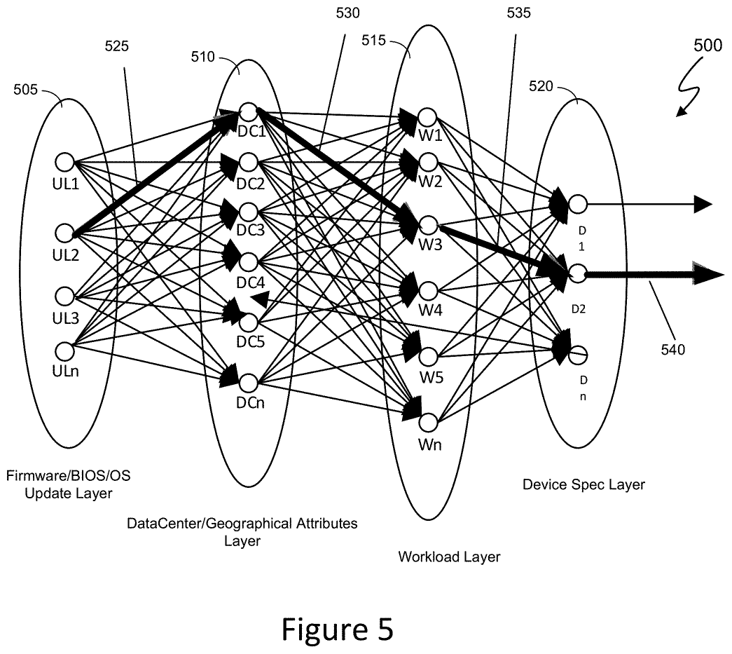

FIG. 5 depicts one example of a neural network 500 that may be used in a warranty cost model in certain embodiments of the invention. As part of an initial set up of the neural network 500, the neural network 500 may be trained using warranty cost factors associated with default warranty provisions that typically accompany transactions involving the information processing system. In certain embodiments, the cost factors are taken into consideration in the generation of an initial set of parameters that are used in the neural network 500. As an example, certain default parameters may be used for the neurons of various layers of the neural network 500, described herein. In certain embodiments, after initial training, the neural network 500 may be trained using customer-specific usage data to provide a projected warranty cost that may be more accurate than the model that is generated using the cost factors associated with default warranty provisions.

In certain embodiments, the neural network 500 is a fully convolutional neural network. As used herein, a fully convolutional neural network is a neural network composed of convolutional layers in which every neuron in a layer is connected with every other neuron in a subsequent layer. In the specific embodiments shown in FIG. 5, the neural network 500 includes four layers 505, 510, 515, and 520. In certain embodiments, layer 505 is a firmware/BIOS/OS update layer. In certain embodiments, layer 505 includes model parameters that have been trained with respect to warranty factors relating to in-field maintenance of the information processing system and recommended updates. In certain embodiments, layer 505 may include neurons UL₁ through Ulₙ. As an example, neurons UL₁ through Ulₙ may correspond to warranty factors relating to the frequency of updates of BIOS, updates of firmware, OS updates, and any other patches (or) bug fixes. As an extension of this example, UL₁ may correspond to warranty factors relating to the update of the BIOS, UL₂ may correspond to warranty factors relating to updates of software for a network interface card, UL₃ may correspond to warranty factors relating to updates of the OS, UL₄ can may represent warranty factors associated with updates of the DIMM firmware, etc. As a further extension to this example, if a manufacturer has provided a critical fix in a patch release, the neural network 500 may be used to assess warranty factors associated with how a customer has done the upgrade, the frequency of the updates, duration between updates, etc.

In certain embodiments of the neural network 500, layers 510 and 515 are hidden layers. In certain embodiments, each neuron DC₁ through DCₙ of layer 510 is configured to accept inputs from each neuron UL₁ through ULₙ of layer 505. In certain embodiments, layer 510 is configured with data corresponding to the datacenter and geographical attributes for the information processing system. In certain embodiments, layer 510 includes neurons relating to warranty cost factors associated with the environment in which the information processing system is operated by the customer. In certain embodiments, such factors may include temperature, humidity, the level of EMI reference levels, etc., of the environment. In certain embodiments, each of these factors may be measured directly by the information processing system. Additionally, or in the alternative, the information processing system may be in communication with one or more sensors that provide data relating to these factors. In certain embodiments, neuron DC₁ can be related to temperature, DC₂ may be related to humidity, DC₃ may be related to be EMI reference level.

In certain embodiments, the geographic region in which the information processing system is operated by the customer may be considered in the warranty cost projection. For example, it may be observed that DIMMS fail frequently in Australia, the same frequency of failures is not observed in other regions. In such instances, warranty costs associated with information processing systems having DIMMS in Australia are expected to be higher than those in other geographical regions.

In certain embodiments, each neuron DC₁ through DCₙ of layer 510 is connected as an input to each neuron W₁ through Wₙ of layer 515. In certain embodiments, layer 515 includes parameters that have been trained with respect to the application workload imposed on the information processing system. In certain embodiments, the workload factors may be based on, without limitation, whether the information processing system is subject to reading intensive operations, writing intensive operations, bandwidth intensive operations, etc. in certain embodiments, workload may correspond to the number of times CPU reaches certain usage capacities, how many tasks are run concurrently. In certain instances, workload factors may also relate to the number of nodes connected to the server. In certain embodiments, W₁ may be associated with reading intensive factors, W₂ may be associated with writing intensive factors, W₃ may be related to the number of incoming requests that the information processing system handles, and W₄ may be related to the number of times CPU reaches certain usage capacities.

In certain embodiments, each neuron W1 through Wn of layer 515 is connected as an input to each neuron D1 through Dn of layer 520. In certain embodiments, layer 515 includes warranty cost factor parameters that are specific to the type of information processing system product. In certain embodiments, this layer provides the detailed information of the specification of the components in a server. In certain embodiments, it may be used to map the collected device health data to device component(s) specific specifications, such as specifications for the CPUs, storage controllers, DIMM slots, NICs, etc., used in the information processing system.

In certain embodiments, the inputs to 520 layer may be validated against actual specification of the components in a device. In certain embodiments, neuron D₁ may correspond to a CPU specification, D₂ may correspond to a DIMM specification, D₃ may correspond to storage controller specifications, etc.

In certain embodiments, the weighted selection at the output of the displaced specification layer 520 may be used as the ultimate factor from which the warranty cost is projected. In this example, the most heavily weighted path between layer 505 and layer 510 is shown at path 525 from neuron UL₂ of layer 505 to neuron DC₁ of layer 510. In this example, the most heavily weighted path between layer 510 and layer 515 is shown at path 530 from neuron DC₁ of layer 510 to neuron W₃ of layer 515. In this example, the most heavily weighted path between layer 515 and layer 520 is shown at path 535 from neuron W₃ of layer 515 to neuron D₂ of layer 520. In this example, the weighted output from which the warranty cost may be projected is shown at the output 540 of neuron D₂.

Various activation functions may be used at the neurons of neural network 500. In certain embodiments, one or more neurons may use a SIGMOID function.

As will be appreciated by one skilled in the art, the present invention may be embodied as a method, system, or computer program product. Accordingly, embodiments of the invention may be implemented in hardware, in software (including firmware, resident software, micro-code, etc.) or in an embodiment combining software and hardware. Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implemented method for determining a projected warranty cost for use of an electronic product comprising:
generating a warranty cost projection model based on historical usage data associated with the electronic product;
acquiring customer specific usage data for the electronic product of an existing customer, wherein the customer specific usage data includes usage data acquired from the electronic product during operation of the electronic product by the existing customer; and
determining a warranty cost projection for use of the electronic product by the existing customer, wherein the warranty cost projection is determined by applying the customer specific usage data to the warranty cost projection model.

2. The computer-implemented method of claim 1, wherein the historical usage data used to generate the warranty cost projection model includes
the customer specific usage data.

3. The computer-implemented method of claim 1, wherein
the customer specific usage data acquired during from the electronic product during operation of the electronic product by the existing customer includes customer specific usage data acquired from the electronic product including one or more of:
geographical location data identifying the geographical location in which the electronic product is operated;
environmental data corresponding to the environmental conditions in which the electronic product is operated;
workload data corresponding to the workload placed upon the electronic product by the existing customer; and
internal diagnostic records corresponding to various hardware and software errors occurring during operation of the electronic product by the existing customer.

4. The computer-implemented method of claim 1, wherein
at least a portion of the specific usage data acquired from the electronic product is obtained using a support tool that is executable by the electronic product.

5. The computer-implemented method of claim 3, wherein
the customer-specific usage data further includes usage data that is not acquired directly from the electronic product, wherein the customer specific usage data that is not directly acquired from the electronic product includes one or more of data relating to communications requesting service of the electronic product;
frequency of maintenance of the electronic product; and
service activities associated with repair of the electronic product.

6. The computer-implemented method of claim 1, wherein the customer specific usage data acquired from the electronic product during operation of the electronic product by the existing customer includes one or more of:
ambient temperature of an environment in which the electronic product is operated;
ambient humidity of an environment in which the electronic product is operated;
internal temperature within a housing of the electronic product during operation of the electronic product;
component temperature of one or more electronic components of the electronic product; and
electronic memory storage activity of the electronic product during operation by the existing customer.

7. The computer-implemented method of claim 1, wherein
the electronic product comprises a server operated at a DataCenter, wherein the customer-specific usage data includes usage data of the server at the DataCenter.

8. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
generating a warranty cost projection model based on historical usage data associated with an electronic product;
acquiring customer specific usage data for use of the electronic product by an existing customer, wherein the customer specific usage data includes usage data acquired from the electronic product during operation of the electronic product by the existing customer; and
determining a warranty cost projection for the electronic product by the existing customer, wherein the warranty cost projection is determined by applying the customer specific usage data to the warranty cost projection model.

9. The system of claim 8, wherein the historical usage data used to generate the warranty cost projection model includes
the customer specific usage data.

10. The system of claim 8, wherein
the customer specific usage data acquired during from the electronic product during operation of the electronic product by the existing customer includes customer specific usage data acquired from the electronic product including one or more of:
geographical location data identifying the geographical location in which the electronic product is operated;
environmental data corresponding to the environmental conditions in which the electronic product is operated;
workload data corresponding to the workload placed upon the electronic product by the existing customer; and
internal diagnostic records corresponding to various hardware and software errors occurring during operation of the electronic product by the existing customer.

11. The system of claim 8, wherein
at least a portion of the customer specific usage data acquired from the electronic product is obtained using a support tool that is executable by the electronic product.

12. The system of claim 10, wherein
the customer-specific usage data further includes usage data that is not acquired directly from the electronic product, wherein the customer specific usage data that is not directly acquired from the electronic product includes one or more of
data relating to communications requesting service of the electronic product;
frequency of maintenance of the electronic product; and
service activities associated with repair of the electronic product.

13. The system of claim 8, wherein the customer specific usage data acquired from the electronic product during operation of the electronic product by the existing customer includes one or more of:
ambient temperature of an environment in which the electronic product is operated;
ambient humidity of an environment in which the electronic product is operated;
internal temperature within a housing of the electronic product during operation of the electronic product;
component temperature of one or more electronic components of the electronic product; and
electronic memory storage activity of the electronic product during operation by the existing customer.

14. The system of claim 8, wherein
the electronic product comprises a server operated at a DataCenter, wherein the customer-specific usage data includes usage data of the server at the DataCenter.

15. A non-transitory, computer-readable storage medium embodying computer program code, the computer program code comprising computer executable instructions configured for:
generating a warranty cost projection model based on historical usage data associated with an electronic product;
acquiring customer specific usage data for use of the electronic product by an existing customer, wherein the customer specific usage data includes usage data acquired from the electronic product during operation of the electronic product by the existing customer; and
determining a warranty cost projection for the electronic product by the existing customer, wherein the warranty cost projection is determined by applying the customer specific usage data to the warranty cost projection model.

16. The non-transitory, computer-readable storage medium of claim 15, wherein the historical usage data used to generate the warranty cost projection model includes
the customer specific usage data.

17. The non-transitory, computer-readable storage medium of claim 15, wherein
the customer specific usage data acquired during from the electronic product during operation of the electronic product by the existing customer includes customer specific usage data acquired from the electronic product including one or more of:
geographical location data identifying the geographical location in which the electronic product is operated;
environmental data corresponding to the environmental conditions in which the electronic product is operated;
workload data corresponding to the workload placed upon the electronic product by the existing customer; and
internal diagnostic records corresponding to various hardware and software errors occurring during operation of the electronic product by the existing customer.

18. The non-transitory, computer-readable storage medium of claim 17, wherein
the customer-specific usage data further includes usage data that is not acquired directly from the electronic product, wherein the customer specific usage data that is not directly acquired from the electronic product includes one or more of
data relating to communications requesting service of the electronic product;
frequency of maintenance of the electronic product; and
service activities associated with repair of the electronic product.

19. The non-transitory, computer-readable storage medium of claim 15, wherein the customer specific usage data acquired from the electronic product during operation of the electronic product by the existing customer includes one or more of:
ambient temperature of an environment in which the electronic product is operated;
ambient humidity of an environment in which the electronic product is operated;
internal temperature within a housing of the electronic product during operation of the electronic product;
component temperature of one or more electronic components of the electronic product; and
electronic memory storage activity of the electronic product during operation by the existing customer.

20. The non-transitory, computer-readable storage medium of claim 15, wherein
the electronic product comprises a server operated at a DataCenter, wherein the customer-specific usage data includes usage data of the electronic product at the DataCenter.
